(19) United States
(12) Patent Application Publication
(10) Pub. No.: US 2021/0048074 A1
(43) Pub. Date: Feb. 18, 2021

(54) PLUG-IN COUPLER FOR CONNECTING SHAFTS

(71) Applicant: Max-Planck-Gesellschaft zur Foerderung der Wissenschaften e.V., Munich (DE)

(72) Inventor: Dietmar Oberdorfer, Goettingen (DE)

(21) Appl. No.: 17/084,879

(22) Filed: Oct. 30, 2020

Related U.S. Application Data
(63) Continuation-in-part of application No. PCT/EP2019/061709, filed on May 7, 2019.

(30) Foreign Application Priority Data
May 8, 2018 (DE) 10 2018 110 987.3
May 18, 2018 (DE) 10 2018 112 084.2

(51) Int. Cl. F16D 7/04; F16D 1/08

(52) U.S. Cl. CPC F16D 7/048; F16D 1/0894

(57) ABSTRACT

A coupler for coupling shafts comprises a virtual main axis, a coupler body, and a shaft socket provided in the coupler body, which is configured and arranged for plugging-in a shaft along the main axis and which includes a leaf spring. The leaf spring has a direction of main extension extending tangentially to a virtual arc of a circle around the main axis. The leaf spring is rigidly supported at the coupler body, and configured and arranged for engaging a circumferential surface of the shaft plugged in the shaft socket.

### CROSS REFERENCE TO RELATED APPLICATIONS

The present application is a continuation in part to international application PCT/EP2019/061709 entitled “Plug-In Coupling for Connecting Shafts”, filed on May 7, 2019 and claiming priority to German patent applications DE 10 2018 110 987.3 filed May 8, 2018 and DE 10 2018 112 084.2 filed May 18, 2018, both entitled “Steckbare Kupplung zur Verbindung von Wellen”.

### FIELD OF THE INVENTION

The present invention relates to a plug-in coupler for connecting shafts.

Such a coupler may be used for rigidly coupling a first shaft in rotational direction about a main axis to a second shaft or another component pivoting about the main axis coaxially with regard to the first shaft. To serve this purpose, the coupler has to be able to transfer torque between the first shaft, on the one hand, and the second shaft or the other component, on the other hand.

The present invention also relates to such a coupler in which the coupling between the first shaft and the second shaft or the other component is present up to a predefined maximum torque, whereas the coupling is interrupted at higher torques.

### BACKGROUND OF THE INVENTION

Patent application publication US 2018/0062307 A1 discloses a connector assembly that has a connector including a coupling member rotatably coupled to a body. A gripping sleeve receives at least a portion of the body and at least a portion of the coupling member. A slip element located at or near the front end of the gripping sleeve and an engaging element located on the coupling member engage one another such that rotation of the gripping sleeve applies torque to and rotates the coupling member in a tightening direction until a predetermined torque limit is reached. Then the slip element disengages from the engaging element allowing the gripping sleeve to rotate with respect to the coupling member such that torque is no longer applied to the coupling member by the gripping sleeve. The coupling element has a substantially hexagonal shaped portion. The hexagonally shaped portion includes engaging elements to frictionally engage flexible fingers of the gripping sleeve. Each flat portion of the coupling member is designed to engage a corresponding flat inner surface portion of the flexible fingers of the gripping sleeve such that, when the gripping sleeve is rotated, the coupling member also rotates until the selected and predetermined torque limit is reached.

In another embodiment of the connector assembly disclosed in US 2018/0062307 A1, a wave-shaped elastic ring is provided for a torque transfer up to the predetermined torque limit between a non-circular inner circumference of the gripping sleeve and a non-circular outer circumference of the coupling element.

U.S. Pat. No. 2,302,110 discloses an overload release clutch in which three leaf springs are fixed to three tangential flattenings of a shaft. Arc segment shaped portions of the leaf springs extend away from the shaft and abut at a cylindrical friction surface at the inner circumference of a coupler body at an elastic pre-stress.

German patent application publication DE 28 47 190 A1 and UK patent application publication GB 2 034 003 A belonging to the same patent family disclose a shaft coupling assembly for connecting the ends of two shafts. An end portion of a first shaft is provided with a flat parallel to its axis, and an end portion of a second shaft has an axial cylindrical bore for receiving the end portion of the first shaft. A spring is held in transverse recesses in the second shaft, and has a curved portion which is engageable with the flat to prevent relative rotation between the shafts. The spring serves to absorb torsional shock loads. The spring is a leaf spring which is curved in its central region, the convex surface of that region being engageable with the flat of the first shaft. The recesses in the second shaft and the sections of the spring received by them are rectilinear. The recesses are disposed in a plane parallel to the axis of the second shaft and extend axially from the end face of the second shaft. Each of the recesses passes through the wall of the second shaft. The ends of the spring projecting beyond the outer periphery of the second shaft are flanged. By means of the known shaft assembly, the ends of the two shafts are not connected without play. Instead, due to the line-shaped abutment of the convex region of the leaf spring at the flat of the first shaft different angles of rotation between the two shafts are possible.

Japanese patent application publication JP 2004-204973 A discloses a power transmission mechanism with torque cut-off performance. The power transmission mechanism is provided with a first rotor of annular shape. A second rotor is positioned inside a central opening of the first rotor. Spring members are inserted between the first rotor and the second rotor. Both ends of each spring member are fixed to or supported at the first rotor. Each spring members is curved into a protrusion shape towards the second rotor and abuts against the outer peripheral surface of the second rotor. The respective outer peripheral surface of the second rotor against which the spring member abuts is a flat surface or a curved surface protruding outwards in radial direction. At an excess torque, the spring members are deformed outwardly and thus release the second rotor in the rotational direction around a common axis of the rotors. As each spring member only abuts against the respective outer peripheral surface of the second rotor along a line parallel to the main axis, this known power transmission is also not free of play in the rotational direction about the main axis.

In contrary to JP 2004-204973 A cited above, German patent application publication DE 103 11 367 A1 discloses a power transmission mechanism in which a convex-shaped leaf spring is pressed into contact with a concave-curved recess in a hub. If the radiuses of curvature of the convex surfaces of the leaf springs and the concave counter-surfaces of the hub are identically, there is no play. However, identical radiuses of curvature require a high manufacturing precision and are thus hardly realized in practice.

European patent application publication EP 1 195 536 A1 and US patent application publication US 2002/0162720 A1 belonging to the same patent family disclose a power transmission mechanism comprising a first rotary body having an engaging projection and a second rotary body located coaxial with the first rotary body and having an engaging recess. The engaging projection engages with the engaging recess to connect the first and second rotary bodies to each other such that power transmission is permitted. An elastic member is elastically deformed by force generated by transmission torque and allows for the rotary bodies rotating relative to each other in a predetermined angular range with the engaging projection sliding in the engaging recess. This is in contradiction to a coupling without play.

There still is a need of a plug-in coupler for connecting shafts which can be provided at compact dimensions and which can be assembled by simply plugging-in, i. e. without tools or other utilities to, for example, connect an output shaft of a rotational drive or an input shaft of a potentiometer or of another rotation angle sensor to a rotating mirror at a defined angle of rotation.

### SUMMARY OF THE INVENTION

The present invention relates to a coupler for coupling shafts. The coupler comprises a virtual main axis, a coupler body, and a shaft socket provided in the coupler body. The shaft socket is configured and arranged for plugging-in a shaft along the main axis and includes a leaf spring. The leaf spring has a direction of main extension extending tangentially to a virtual arc of a circle around the main axis. The leaf spring is rigidly supported at the coupler body, and configured and arranged for engaging a circumferential surface of the shaft plugged in the shaft socket.

Further, the present invention relates to a coupling device comprising a coupler and a first shaft fitting. The coupler comprises a virtual main axis, a coupler body, and a first shaft socket provided in the coupler body and including a first leaf spring. The first leaf spring has a direction of main extension extending tangentially to a first virtual arc of a circle around the main axis, and is rigidly supported at the coupler body. The first shaft fits into the first shaft socket and comprises a virtual first shaft axis, and a circumferential surface having a first flattening extending tangentially to a second virtual arc of a circle around the first shaft axis. The first leaf spring of the first shaft socket engages the circumferential surface of the first shaft and at least locally abuts at an elastic pre-stress against the first flattening of the circumferential surface of the first shaft plugged in the first shaft socket.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a perspective view of a first embodiment of a first coupling device of the invention in an unassembled state.

FIG. 2 is a cross section through the assembled coupling device according to FIG. 1.

FIG. 3 is a perspective view of a coupler body of another embodiment of the invention than the coupling device according to FIG. 1.

FIG. 4 is a perspective sectional view of an assembled coupling device, comprising the coupler of FIG. 3.

FIG. 5 is a perspective view of a variant of the coupler according to FIG. 4.

FIG. 6 is a perspective view of a further variant of the coupler according to FIG. 4.

FIG. 7 is a perspective view of even a further variant of the coupler according to FIG. 4,

FIG. 8 is a cross section through the coupler according to FIG. 7.

FIG. 9 is a perspective view of even a further variant of the coupler according to FIG. 4.

FIG. 10 is a cross section through the coupler according to FIG. 9.

FIG. 11 is a cross section through a further embodiment of the coupling device according to the invention in an assembled state.

FIG. 12 is a cross section through even a further embodiment of the coupling device according to the invention in an assembled state.

FIG. 13 shows an application of the coupler according to the invention.

FIG. 14 is a perspective longitudinal sectional view of a further embodiment of the coupler according to the invention prior to assembly.

FIG. 15 is a perspective longitudinal sectional view of the coupler according to FIG. 14 in an assembled state; and

FIG. 16 shows an application of the coupler of the invention according to FIGS. 14 and 15.

### DETAILED DESCRIPTION

According to the present invention, a coupler for coupling shafts comprises a virtual main axis, a coupler body and a shaft socket provided in the coupler body. The first shaft socket comprises at least one leaf spring which is supported at the coupler body and which is configured and arranged for engaging a circumferential surface of a first shaft plugged in the first shaft socket. The at least one leaf spring has a direction of main extension extending tangentially to a virtual arc of a circle around the main axis. The first leaf spring of the coupler according to the invention has an essentially plane shape extending along its direction of main extension. The leaf spring is supported at the coupler body comprising the first shaft socket into which the first shaft can be plugged-in. Thus, the first leaf spring rotates together with the coupler body about the main axis. The leaf spring engages the circumferential surface of the first shaft extending around the main axis, i. e. the first leaf spring engages the first shaft from the outside, when the first shaft is plugged into the first shaft socket. By means of this engagement of the leaf spring at the first shaft, torque can be transferred between the first shaft and the coupler body. Besides the stiffness of the leaf spring, the size of the torque which can be transferred depends on the shape or course of the circumferential surface of the first shaft. If the circumferential surface of the first shaft has a flattening against which the first leaf spring can abut a certain angle of rotation position of the first shaft with regard to the coupler body is defined via this abutment. In other words, the coupler according to the invention is free of play. If the first shaft has a tapering free end, this papering free end can be inserted into the first shaft socket independently of whether the defined rotational angle position is kept or not. Via the tapering free end, the first shaft elastically deflects the first leaf spring. With a small deviation of the shaft from the defined rotational position with regard to the coupler body, a relative rotation of the shaft with regard to the coupler body, which results in an abutment of the first leaf spring at the fattening of the first shaft, automatically results. Otherwise, this abutment may be caused by a torque applied between the first shaft and the coupler body.

The formulation “a direction of main extension extending tangentially to a virtual arc of a circle around the main axis” means that the direction of main extension extends along a tangent line to the virtual arc of a circle around the main axis. The feature of the coupler according to the present invention defined by this formulation does not require that the direction of main extension is a straight direction exactly running in parallel to a tangent line to the virtual arc of a circle around the main axis. Instead, it is sufficient if the direction of main extension essentially is a straight direction and essentially runs in parallel to such a tangent line. Generally, all formulations indicating a movement or extension “along” a particular direction do not require that the movement or extension is exactly in the indicated direction. It is sufficient if the movement or direction essentially is in that direction.

The adjective “virtual” used in defining certain features of the coupler according to the present invention indicates that the respective object is no object which could be seen or even grabbed as such. Nevertheless it can be clearly determined whether the coupler according to the present invention has these virtual features or not.

The first leaf spring has a transverse extension direction orthogonal to its direction of main extension. This transverse extension direction extends along the virtual main axis. Preferably, the transverse extension direction of the leaf spring is parallel to the virtual main axis.

Preferably, the first leaf spring is supported at the coupler body at both of its ends in its direction of main extension. The leaf spring supported at both of its ends has a higher effective stiffness with regard to deflections away from the main axis as compared to its modulus of elasticity than a leaf spring only supported at one of its ends. Further, a leaf spring supported at both of its ends is suitable for an abutment against both ends of a flattening of the first shaft such that the defined rotational angle position of the first shaft with regard to the coupler body is precisely kept up to reaching a maximum torque which can be transferred by the coupler according to the invention. The defined rotational angle position of the first shaft with regard to the coupler body may also precisely be kept up to reaching the maximum torque transferable by means of the coupler according to the invention in that the leaf spring has a shaped abutment area which flatly abuts against the flattening of the first shaft at a pre-stress. Such an abutment area may also be provided at a first leaf spring which is supported at the main body at one of its ends only.

The first leaf spring is rigidly, i. e. neither via a joint nor otherwise movable, supported at the coupler body. Essentially, the coupler body is only moveable due to the elastic deformability of the first leaf spring, which, however, is sufficient for its function, and otherwise the coupler body is a rigid unit. Preferably, the leaf spring is not only supported at the coupler body but an integral part of the coupler body. For example, the first leaf spring may be formed in one piece together with the coupler body. Particularly, the coupler body and the first leaf spring may be milled out of a blank with a uniform composition or molded in a mold from a single material. However, in forming the coupler according to the invention in a mold, different materials may also be used. For example, a first leaf spring made of metal may be embedded at its ends by injecting plastic to form the remainder of the coupler body.

If the first shaft socket has a second leaf spring which is axially symmetrically configured and arranged with regard to the first leaf spring, the coupler according to the invention is suited to compensate for angle errors and eccentricities of the first shaft with regard to the main axis of the coupler by means of elastic deformations of the leaf springs.

For the purpose of making it easy to plug-in the first shaft into the first shaft socket, the first shaft socket may have an outer shaft guide including first cylindrical surfaces at its free axial end in front of the leaf spring. This first cylindrical surfaces are partial surfaces of a first virtual cylinder coaxially arranged with regard to the main axis. The radius of this first cylinder is larger than a distance of the first leaf spring to the main axis. It is to be understood that the radius of the virtual first cylinder has to be large enough that the first shaft can be plugged into the first shaft socket, i. e. slightly larger than a maximum radius of the first shaft. For the purpose of centering the first shaft to the main axis by means of the first shaft guide, the radius of the first cylinder must not be much larger than the maximum radius of the first shaft.

If the coupler according to the invention, in the first shaft socket, shall be able to compensate for angle errors and eccentricities of the first shaft with regard to the main axis, the radius of the first cylinder has even to be significantly larger than the maximum radius of the first shaft. The outer shaft guide ensures that the first shaft is at least pre-aligned with regard to the coupler body before it encounters the leaf springs. In this way it can be avoided that a miss-aligned first shaft damages the leaf springs when plugged-in.

At its inner axial end behind the leaf springs, the first shaft socket may have an inner shaft guide with a second cylindrical surface, the second cylindrical surface being at least a part of a surface of a second virtual cylinder coaxially arranged with regard to the main axis, whose radius is smaller than the distance of the first leaf spring to the main axis. This second inner shaft guide may receive a cylindrical appendix of the first shaft, which is reduced in radius, to further align the first shaft with regard to the main axis of the coupler body. With a tight fitting of the outer and inner shaft guides with regard to the first shaft, a coaxial alignment of the first shaft with regard to the main axis can be provided for. It is to understood that the coupler according to the invention then has to have additional features if eccentricities and angle errors of the first shaft shall be compensated for.

A second shaft coaxially arranged with regard to the main axis may be directly formed at the coupler body. Alternatively, a second shaft socket for a second shaft corresponding to the first shaft socket for the first shaft can be formed at the coupler body. In a projection along the main axis, the first leaf spring of the first shaft socket and a first leaf spring of the second shaft socket may then be parallel or orthogonal to one another, although, in principle, any angles between the two leaf springs are possible. The arrangements of the first leaf springs of the first and the second shaft sockets may be adapted to first and second shafts which are equal or unequal—particular with regard to their radiuses—, i. e. the first leaf springs of the first and the second shaft sockets may have same or different distances to the main axis. Any inner and/or outer shaft guides may also be adapted to equal or unequal first and second shafts.

To compensate for angle errors of the first shaft with regard to a second shaft formed at the coupler body or to a second shaft inserted into a second shaft socket of the coupler body, the coupler body may have a biaxial joint, particularly a biaxial solid-body joint, between the first shaft socket and the second shaft or the second shaft socket.

In a coupling device according to the present invention comprising the coupler according to the present invention and a first shaft having a first shaft axis, which is plugged in or to be plugged into the first shaft socket, the circumferential surface of the first shaft has at least a first flattening extending tangentially to a second virtual arc of a circle around the first shaft axis and along the first shaft axis, against which the first leaf spring of the first shaft socket at least locally abuts at an elastic pre-stress. If this flattening of the first shaft is symmetric to a mirror plane through which the main axis runs, and if the first leaf spring with plugged-in first shaft is also mirror-symmetrically arranged and configured with regard to this mirror plane, the maximum torque transferable by the coupling device according to the invention is equal in both rotational directions about the main axis. However, if, for example, the at least one first flattening of the first shaft is provided with different increases or gradients of the distance to the first shaft axis in the two rotational directions about the first shaft axis, different maximum torques in the two rotational directions can also be realized. Thus, the coupling device according to the invention can be configured for transferring an at least twice as high torque in the one rotational direction than in the other rotational direction. In this way, for example, a rotational stop for the second shaft may be approached at a limited torque of a drive comprising the first shaft in the one rotational direction, whereas a higher torque can be transferred for removing the second shaft from the rotational stop in the other rotational direction.

As already mentioned further above, a maximum radius of the first shaft may be gradually reduced in an end region towards a free axial end of the first shaft to facilitate the insertion of the first shaft into the first shaft socket with elastic radial deflection of the first leaf spring.

The coupling device according to the invention may in a simple way be configured such that the first shaft plugged in the first shaft socket is securely but nevertheless releasable held within the first shaft socket in the axial direction of the main axis. If, for this purpose, the first flattening towards the free axial end of the first shaft is delimited by a snap-fit flange in which the radius of the first shaft increases beyond the distance of the first flattening to the first shaft axis, the first leaf spring snapping-in behind the snap-fit flange when plugging the first shaft into the first shaft socket, the leaf spring also serves as a snap-fit element for axially securing the first shaft. Further, securing the first shaft in the first shaft socket by means of the leaf spring may be released by means of a relative rotation of the first shaft with regard to the coupler until the leaf spring abuts against the first shaft outside the flattening and is thus no longer stopped by the snap-fit flange. The snap-fit flange may be formed in that the first flattening is worked into a cylindrical part of the first shaft, at a distance to an end of this cylindrical part pointing towards the free axial end of the first shaft.

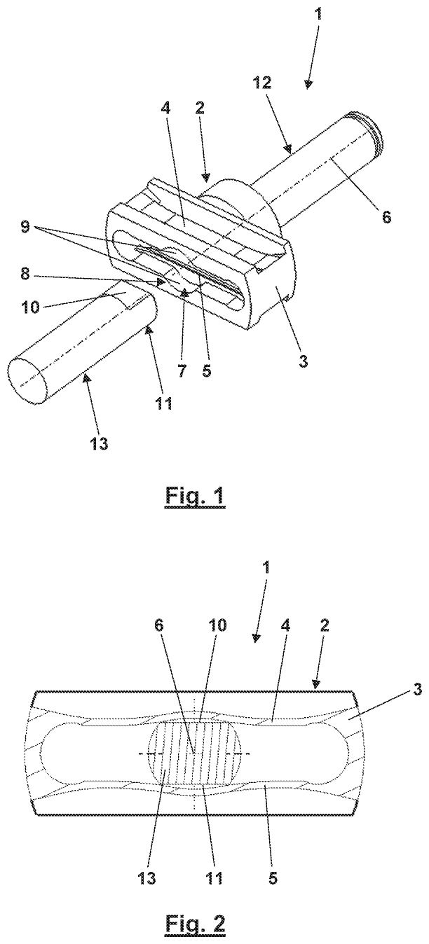

Referring now in greater detail to the drawings, the coupling device 1 depicted in FIG. 1 includes a coupler 2 and a first shaft 13. The coupler 2 has a coupler body 3 which is made as one piece together with a first leaf spring 4 and a second leaf spring 5. Directions of main extension of the leaf springs 4 and 5 run tangentially to a virtual arc of a circle around a main axis 6 of the coupler 2. Transverse extension directions of the leaf springs 4 and 5 are parallel to the main axis 6, and, with regard to the main axis 6, the leaf springs 4 and 5 are axially symmetrically formed and arranged with regard to each other. Here, each of the two leaf springs 4 and 5 is rigidly supported at the coupler body 3 at both of its ends in its direction of main extension. By means of the leaf springs 4 and 5, a first shaft socket 7 is formed in the coupler body 3, the shaft socked comprising an outer shaft guide 8 with first cylindrical surfaces 9 at its free axial end in front of the leaf springs 4 and 5. The first cylindrical surfaces 9 are partial surfaces of a first cylinder coaxially arranged with regard to the main axis 6, whose radius is larger than a distance of the leaf springs 4 and 5 to the main axis 6 and also slightly larger than a maximum radius of the first shaft 3. When the first shaft 12 is plugged into to the first shaft socket 7, the outer shaft guide 8 serves for aligning the first shaft 12 coaxially to the main axis 6 and thus also with regard to the leaf springs 4 and 5 such that the leaf springs 4 and 5 are not damaged but only slightly radially deflected until the first leaf spring 4 and the second leaf spring 5 abut against a first flattening 11 of the shaft 3 and a second flattening 11 of the shaft 3 axially symmetrically arranged with regard to the first flattening 10, which will be explained in more detail in the next paragraph. Further, the outer shaft guide 8 serves for centering the first shaft 12 to the main axis 6. A second shaft 12 which is coaxially oriented with regard to the main axis 6 is formed at the coupler body 3 of the coupling device 2. The coupler 2 serves for transferring torques around the main axis 6 which do not exceed an upper torque limit between the shafts 13 and 12.

FIG. 2 shows how the leaf springs 4 and 5 of the coupler 2 abut against the flattenings 10 and 11 of the plugged-in first shaft 13. The leaf springs 4 and 5 contact the shaft 13 at the ends of the flattening 10 and 11 in circumferential direction around the main axis 6 in a line-shaped way along the main axis 6. Via these line-shaped contact areas, the torque is transferred between the coupler 2 and the shaft 13. Here, there is no relative rotation of the first shaft 13 with regard to the coupler 2 until the torque further deforms the pre-stressed leaf springs 4 and 5. With an even higher torque, the leaf springs 4 and 5 give way to the flattened first shaft 13 arranged between them.

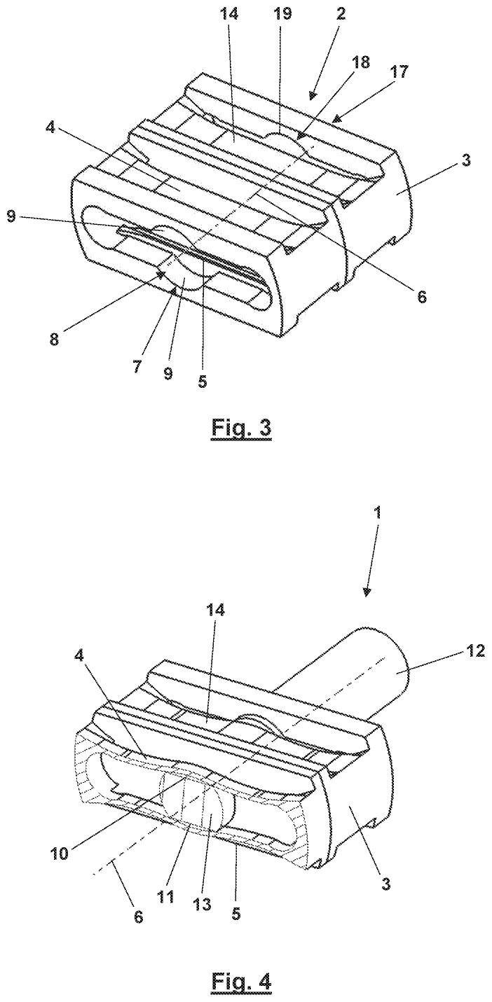

FIG. 3 shows an embodiment of the coupler 2 in which a second shaft socket 17 with first leaf spring 14 and second leaf spring 15 and outer shaft guide 18 comprising cylindrical surfaces 19 is formed. The leaf springs 14 and 15 of the second shaft socket 17 are parallel to the leaf springs 4 and 5 of the first shaft socket 7. Die outer shaft guides 8 and 9 ensure a concentricity of the coupler 2 with regard to the shafts plugged into the shaft sockets 7 and 17.

FIG. 4 shows the assembled or plugged together coupling device 1 comprising the coupler 2 according to FIG. 3 in a perspective sectional view, from which the abutment of the slightly deformed leaf springs 4, 5, 14, 15 at the flattenings 10 and 11 of the shafts 12 and 13 can be seen.

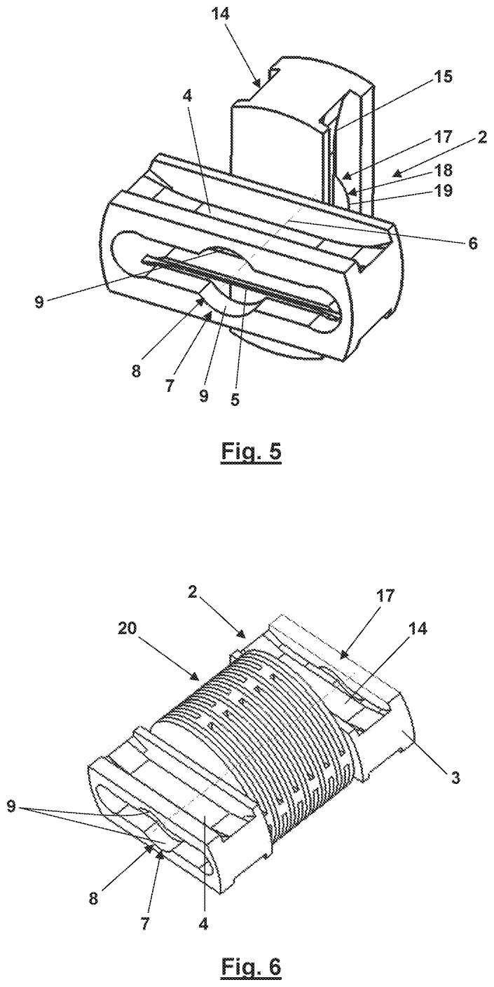

FIG. 5 shows a variant of the coupler 2 according to FIG. 3, in which the directions of main extension of the leaf springs 14 and 15 of the second shaft socket 17, in a projection along the main axis 6, are orthogonal to the directions of main extension of the leaf springs 4 and 5 of the first shaft socket 7.

FIG. 6 shows a coupler 2 which differs from the coupler 2 according to FIG. 3 in that a biaxial solid-body joint 20 is formed between the shaft sockets 7 and 17 to compensate for angle miss-alignments of the shafts 12 and 13 not depicted here.

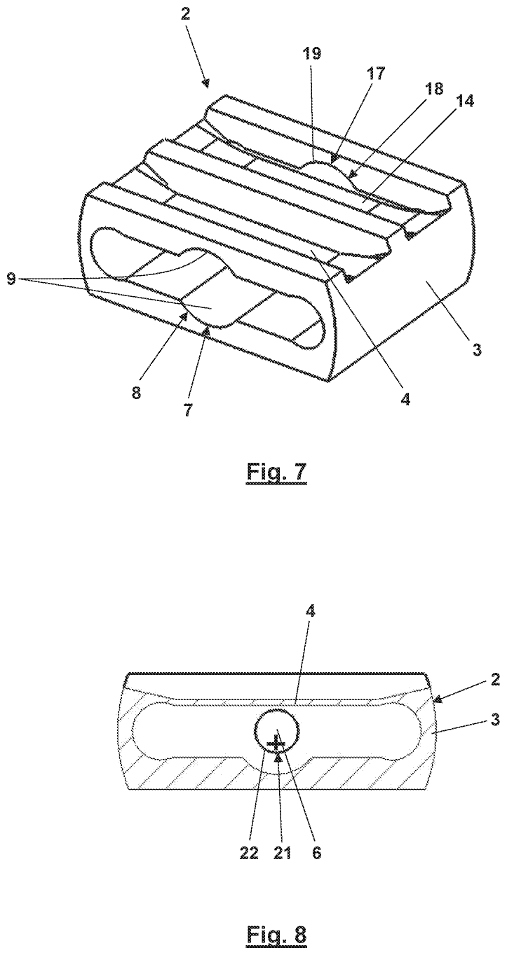

FIG. 7 shows a variant of the coupler 2 according to FIG. 3 in which each of the two shaft sockets 7 and 17 only has one leaf spring 14. Further, it is indicated in FIG. 7 that the first shaft socket 7, at least with regard to its leaf spring 4, is configured in another way than the second shaft socket with regard to its leaf spring 14. There may also be further differences between the shaft sockets 7 and 17.

The cross section according to FIG. 8 additionally shows an inner shaft guide 21 with a second cylindrical surface 22 which is at least a Part of a surface of a second cylinder coaxially arranged with regard to the main axis 6. The radius of the second cylinder is smaller than the distance of the first leaf spring 14 to the main axis 6. This inner shaft guide 21 may receive an appendix of the first and/or second shaft 13, 12, which is reduced in radius, and may thus further align this shaft 13, 12 with regard to the main axis of the coupler body 3.

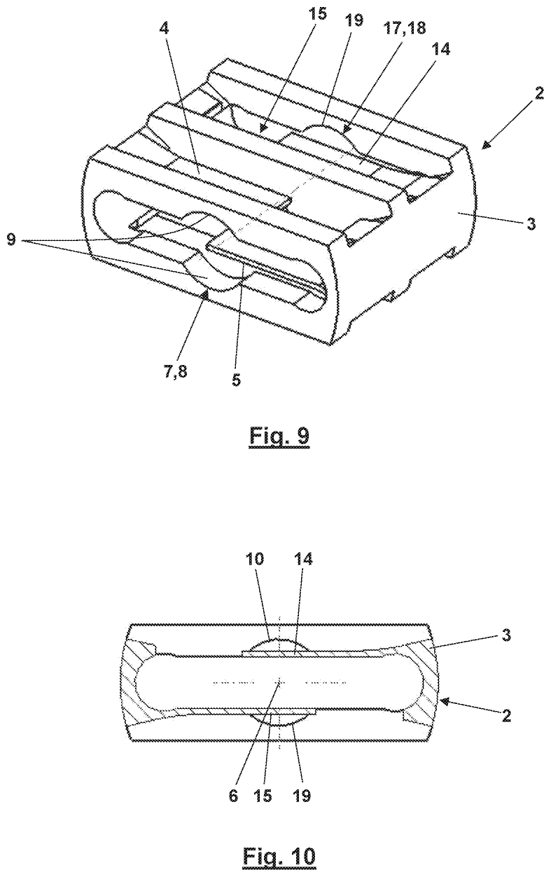

FIG. 9 shows a variant of the coupler 2 according to FIG. 3 in which the leaf springs 4, 5 14, 15 are only rigidly supported at the coupler body 3 at their respective one end in their respective direction of main extension and in which the leaf springs 4, 5, 14, 15 are free with their other ends. In this way, the effective stiffness of the leaf springs 4, 5, 14, 15 is smaller than in the embodiments of the coupler 2 described up to here. The free ends of the leaf springs 14 and 15 can also clearly be seen from the sectional view according to FIG. 10.

FIG. 11, by means of a section which generally corresponds to FIG. 2, illustrates how, by means of how the flattenings 10 and 11 of the first shaft 13 taper off, the maximum torque transferable by means of the coupler 2 can be determined differently in the two rotational directions about the main axis 6. The maximum torque depends on a gradient at which the diameter of the shaft 13 between the leaf springs 4 and 5 increases upon rotating the first shaft 13 with regard to the coupler 2. Due to the rounded ends of the flattenings 10 and 11 depicted in FIG. 11, the maximum torque transferable is reduced. According to FIG. 11, the maximum torque transferable with rotating the first shaft 13 with regard to the coupler 2 anti-clockwise is much smaller than with rotating it clockwise.

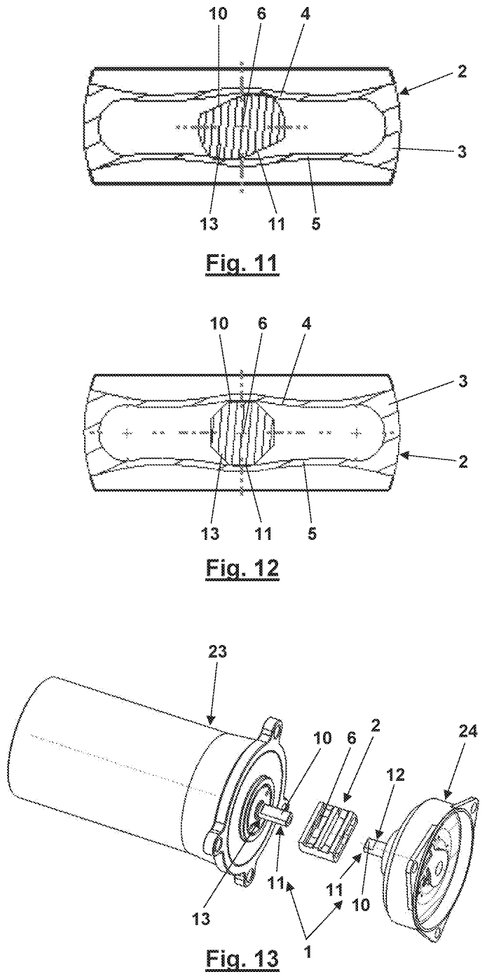

FIG. 12 illustrates in a sectional view how, here by means of a hexagonal outer shape of the first shaft 13 with correspondingly shorter flattenings 10 and 11 in the circumferential direction around the main axis 6, the torque transferable in the two rotational directions about the main axis 6 may be reduced to provide a slipper clutch effective in both rotational directions about the main axis 6.

FIG. 13 illustrates a possible application of the coupler 2 for providing a coupling connection between a motor 23 whose output shaft is the first shaft 13, and a potentiometer 14 whose input shaft is the second shaft 12. Both shafts are provided with flattenings 10, 11 which are aligned in parallel to each other and kept parallel to each other by means of the coupler 2 as long as the torque between the shafts 12 and 13 does not exceed the maximum torque transferable by means of the coupler 2.

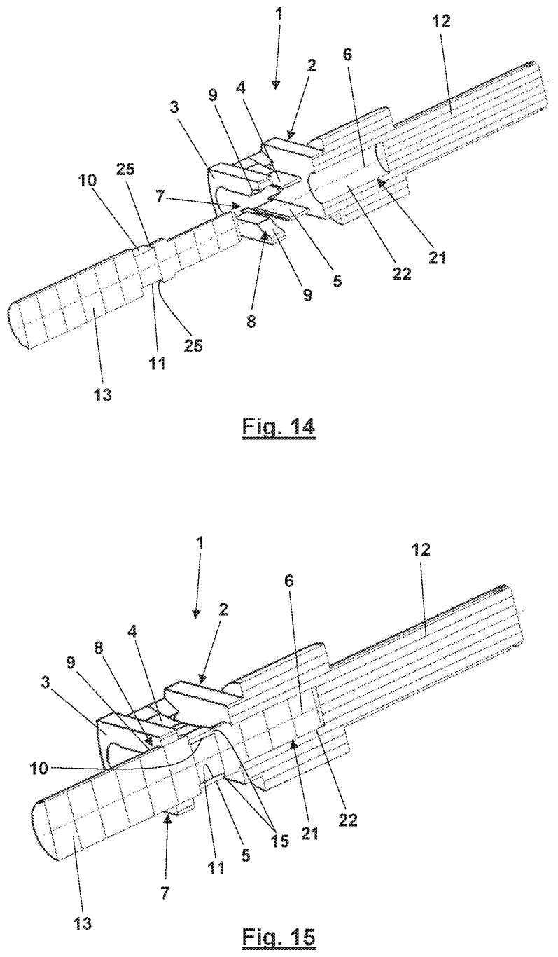

The coupler connection depicted in FIGS. 14 and 15 shows two special features. On the one hand, the inner shaft guide 21 for the free end of the first shaft 13 is comparatively long in the direction of the main axis 6 to coaxially align and support the first shaft 13 with regard to the second shaft 12. At the other hand, each of the flattenings 10 and 11, towards the free end of the first shaft, ends at a snap-fit flange 25 at which the radius of the first shaft 13 step-wise increases up to its unflattened level again. Thus, the leaf springs 4 and 5, when they abut against the flattenings 10 and 11 upon plugging the first shaft 13 into the first shaft socket 7, snap-fit behind the snap-fit flanges 25. By means of this snap-fit connection, the first shaft is secured within the coupler 2 in the axial direction of the main axis 6. This securing may, however, be released by rotating the first shaft 13 with regard to the coupler 2 about the main axis 6 until the leaf springs no longer abut against the flattenings 10 and 11 but against the non-flattened shaft 13 and are thus no longer arranged behind the snap-fit flanges 25.

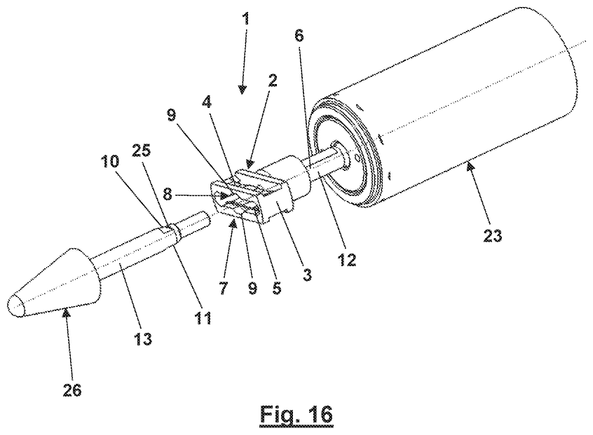

FIG. 16 shows an application of the coupling device 1 according to FIGS. 14 and 15 for connecting a grinding stone 16 fixed for rotation to the first shaft 13 to the second shaft 12 which is the output shaft of an electromotor 23 as a rotational drive for the grinding stone 26, here. The leaf springs 4 and 5 snap-fitted behind the snap-fit noses 25 support the grinding stone 26 at the electromotor 23 in the axial direction of the main axis 6.

The coupler according to the invention is suitable for radiuses of the first shaft 13 and correspondingly also of the second shaft 12 starting from 0.5 mm. The coupler according to the invention is suitable for any combination of drive source and driven acceptor, for example in a generator, a winch, an automation technology and in robots. The maximum dimensions of the coupler 2 are typically 5 to 10 times as large as the radius of the first shaft or the second shaft depending on which of these two shafts has the larger radius. For forming the coupler body 3 with the leaf springs 4, 5, 14, 15 in one piece, the coupler 2 may be made by material adding techniques, like in a mold or a forming tool, or by material removing techniques starting from a massive blank. A multi-part design with leaf springs 4, 5, 14, 15 rigidly mounted to the coupler body 3 is also possible.

Many variations and modifications may be made to the preferred embodiments of the invention without departing substantially from the spirit and principles of the invention. All such modifications and variations are intended to be included herein within the scope of the present invention, as defined by the following claims.

We claim:

1. A coupler for coupling shafts, the coupler comprising:
a virtual main axis,
a coupler body, and
a first shaft socket provided in the coupler body, configured and arranged for plugging-in a first shaft along the main axis and including a first leaf spring,
wherein the first leaf spring has a direction of main extension extending tangentially to a virtual arc of a circle around the main axis,
wherein the first leaf spring is rigidly supported at the coupler body, and
wherein the first leaf spring is configured and arranged for engaging a circumferential surface of the first shaft plugged in the first shaft socket.

2. The coupler of claim 1, wherein the first leaf spring is an integral part of the coupler body.

3. The coupler of claim 1, wherein the first leaf spring has a transverse extension direction which is parallel to the virtual main axis.

4. The coupler of claim 3, wherein the first leaf spring has a plane shape extending along its direction of main extension.

5. The coupler of claim 1, wherein the first leaf spring, at both of its ends in its direction of main extension, is supported at the coupler body.

6. The coupler of claim 1, wherein the first shaft socket comprises a second leaf spring which is axially symmetrically configured and arranged with regard to the first leaf spring.

7. The coupler of claim 1, wherein the first shaft socket has an outer shaft guide including first cylindrical surfaces at its free axial end in front of the first leaf spring, wherein the first cylindrical surfaces are partial surfaces of a first virtual cylinder coaxially arranged with regard to the main axis, whose radius is larger than a distance of the first leaf spring to the main axis.

8. The coupler of claim 7, wherein the first shaft socket, at its inner axial end behind the first leaf spring, has an inner shaft guide including a second cylindrical surface, wherein the second cylindrical surface is at least a part of a surface of a second virtual cylinder coaxially arranged with regard to the main axis, whose radius is smaller than the distance of the first leaf spring to the main axis.

9. The coupler of claim 1, wherein the coupler is fixed to a second shaft coaxially arranged with regard to the main axis.

10. The coupler of claim 1, wherein a second shaft socket configured and arranged for plugging-in a second shaft along the main axis is provided in the coupler body and facing away from the first shaft socket.

11. The coupler of claim 10, wherein the second shaft socket is symmetrically configured and arranged with regard to the first shaft socket.

12. The coupler of claim 10, wherein, in a projection along the main axis, the first leaf spring of the first shaft socket and a first leaf spring of the second shaft socket are parallel or orthogonal to each other.

13. The coupler of claim 10, wherein the first leaf spring of the first shaft socket and a first leaf spring of the second shaft socket are arranged at same or different distances to the main axis.

14. The coupler of claim 1, wherein the coupler body comprises a solid-body joint arranged between the first shaft socket, on the one hand, and a second shaft or a second shaft socket facing away from the first shaft socket in the direction of the main axis, on the other hand.

15. A coupling device comprising
a coupler, the coupler comprising:
a virtual main axis,
a coupler body, and
a first shaft socket provided in the coupler body and including a first leaf spring,
wherein the first leaf spring has a direction of main extension extending tangentially to a first virtual arc of a circle around the main axis, and
wherein the first leaf spring is rigidly supported at the coupler body, and
a first shaft fitting into the first shaft socket, the first shaft comprising:
a virtual first shaft axis, and
a circumferential surface having a first flattening extending tangentially to a second virtual arc of a circle around the first shaft axis and
wherein the first leaf spring of the first shaft socket engages the circumferential surface of the first shaft and at least locally abuts at an elastic pre-stress against the first flattening of the circumferential surface of the first shaft plugged in the first shaft socket.

16. The coupling device of claim 15, wherein the first leaf spring has a plane extension along its direction of main extension, and wherein the first leaf spring abuts against the first flattenings in two areas which are arranged at a distance in the direction of the second virtual arc of a circle.

17. The coupling device of claim 15, wherein, in a first end region of the first shaft, a maximum radius of the first shaft decreases towards a free axial end of the first shaft.

18. The coupling device of claim 15, wherein the first flattening tapers off in two rotational directions around the first shaft axis at same or at different gradients of a distance to the first shaft axis.

19. The coupling device of claim 15, wherein the first flattening is delimited towards a free axial end of the first shaft by a snap-fit flange in which a radius of the first shaft increases beyond a distance of the first flattening to the first shaft axis, wherein the first leaf spring snap-fits behind the snap-fit flange when plugging the first shaft into the first shaft socket.

20. The coupling device of claim 15,
wherein the first leaf spring is an integral part of the coupler body and, at both of its ends in its direction of main extension, supported at the coupler body,
wherein the first shaft socket comprises a second leaf spring which is axially symmetrically configured and arranged with regard to the first leaf spring,
wherein the first shaft socket has an outer shaft guide including first cylindrical surfaces at its free axial end in front of the first leaf spring, wherein the first cylindrical surfaces are partial surfaces of a first virtual cylinder coaxially arranged with regard to the main axis, whose radius is larger than a distance of the first leaf spring to the main axis, and
wherein the first shaft socket, at its inner axial end behind the first leaf spring, has an inner shaft guide including a second cylindrical surface, wherein the second cylindrical surface is at least a part of a surface of a second virtual cylinder coaxially arranged with regard to the main axis, whose radius is smaller than the distance of the first leaf spring to the main axis.
